(19) United States
(12) Patent Application Publication
(10) Pub. No.: US 2026/0091660 A1
(43) Pub. Date: Apr. 2, 2026

(54) REMOVABLE BATTERY STORAGE FOR OUTDOOR POWER EQUIPMENT

(71) Applicant: Ariens Company, Brillion, WI (US)

(72) Inventors: Kevin A. Spatchek, Greenleaf, WI (US); Christopher T. Forrest, Manitowoc, WI (US)

(21) Appl. No.: 19/112,724

(22) PCT Filed: Sep. 21, 2023
(86) PCT No.: PCT/US2023/074740

§ 371 Date: Mar. 18, 2025

Related U.S. Application Data
(60) Provisional application No. 63/376,562, filed on Sep. 21, 2022.

(51) Int. Cl. B60K 1/04; A01D 34/00; A01D 69/02; A01D 101/00

(52) U.S. Cl. CPC B60K 1/04; A01D 34/006; A01D 69/02; A01D 2101/00; B60K 2001/0411; B60K 2001/0466; B60Y 2200/223

(57) ABSTRACT

A utility vehicle including a frame, a battery compartment, a battery pack, a motor, a ground engaging element, and a control. The battery compartment is supported by the frame and has an internal bus bar. The battery compartment had a housing and a lid pivotally coupled to the housing at a pivot point positioned proximate a first side of the vehicle. The battery pack is removably supported within the battery compartment and is placed in electrical contact with a power circuit as a consequence of being inserted into the battery compartment and removed from electrical contact with the power circuit as a consequence of being removed from the battery compartment. The lid is configured to be movable between a closed position and an open position where the battery pack within the battery compartment is accessible by the operator from a second side of the vehicle.

### CROSS-REFERENCE TO RELATED APPLICATION

This application claims priority to U.S. Provisional Ser. No. 63/376,562 filed Sep. 21, 2021, the entire content of which is incorporated herein by reference.

### BACKGROUND

The present invention relates to removable battery storage for an electric outdoor power equipment vehicle, such as an electric zero-turn radius lawn mower.

### SUMMARY

In one embodiment, the invention provides a utility vehicle having a front end, a rear end, a first side extending between the front and rear ends, and a second side extending between the front and rear ends opposite the first side. The utility vehicle includes a frame defining a longitudinal axis that extends centrally through the vehicle from the rear end to the front end of the vehicle, a battery compartment supported by the frame and having an internal bus bar, the battery compartment having a housing and a lid pivotally coupled to the housing at a pivot point positioned proximate the first side of the vehicle, a battery pack removably supported within the battery compartment, the battery pack being placed in electrical contact with a power circuit as a consequence of being inserted into the battery compartment and removed from electrical contact with the power circuit as a consequence of being removed from the battery compartment, a motor supported by the frame and in electrical communication with the power circuit to receive power from the battery pack, a ground engaging element supporting the frame with respect to a ground surface and rotatable under the influence of the motor to move the utility vehicle over the ground surface, and a control operably connected to the power circuit to control a direction and speed of rotation of the ground engaging element under the influence of the motor. The lid is configured to be movable between a closed position where the battery pack is covered within the battery compartment and an open position where the battery pack within the battery compartment is accessible by the operator from the second side of the vehicle.

In another embodiment, the invention provides a utility vehicle including a frame, a battery compartment coupled to the frame and having an internal busbar, a battery pack removably supported within the battery compartment, the battery pack being placed in electrical contact with a power circuit as a consequence of being inserted into the battery compartment and removed from electrical contact with the power circuit as consequence of being removed from the battery compartment, a motor supported by the frame and in electrical communication with the power circuit to receive power from the battery pack, a ground engaging element supporting the frame with respect to a ground surface and rotatable under the influence of the motor to move the utility vehicle over the ground surface, a control operably connected to the power circuit to control a direction and speed of rotation of the ground engaging element under the influence of the motor, an operator platform coupled to the frame and configured to support a standing operator to enable the standing operator to manipulate the control while standing on the platform, and a step plate coupled to the frame at a position proximate the battery compartment, the step plate configured to support the operator to facilitate insertion and removal of the battery pack with respect to the battery compartment.

In another embodiment, the invention provides a utility vehicle including a frame, a battery compartment supported by the frame and configured to support a battery pack, the battery pack placed in electrical contact with a power circuit, a motor supported by the frame and in electrical communication with the power circuit to receive power from the battery pack, a cutting deck coupled to the frame, a cutting blade mounted below the cutting deck to cut vegetation under the cutting deck, a ground engaging element supporting the frame with respect to a ground surface and being rotatable under the influence of the motor to move the utility vehicle over the ground surface, a control operably connected to the power circuit to control a direction and speed of rotation of the ground engaging element under the influence of the motor, and a step plate coupled to the cutting deck at a position proximate the battery compartment, the step plate configured to support the operator to facilitate insertion and removal of the battery pack with respect to the battery compartment.

Other aspects of the invention will become apparent by consideration of the detailed description and accompanying drawings.

### BRIEF DESCRIPTION OF THE DRAWINGS

FIG. 1 is a front left perspective view of an electric zero-turn radius lawn mower embodying the present invention.

FIG. 2A is a rear left perspective view of the lawn mower illustrating an operator platform in a first position.

FIG. 2B is a rear left perspective view of the lawn mower illustrating the operator platform in a second position.

FIG. 3 is a top view of the lawn mower.

FIG. 4 is a left view of the lawn mower.

FIG. 5 is a front left perspective view of the lawn mower with a lid of a battery compartment removed.

FIG. 6 is a left side view of the lawn mower with the lid of the battery compartment removed.

FIG. 7 is a perspective view of a step plate mounted on a mower deck of the lawn mower.

FIG. 8 is a front left perspective view of the lawn mower with the lid of the battery compartment in an open position

FIG. 9 is a perspective view of the battery compartment of lawn mower, illustrating a storage compartment within the battery compartment.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

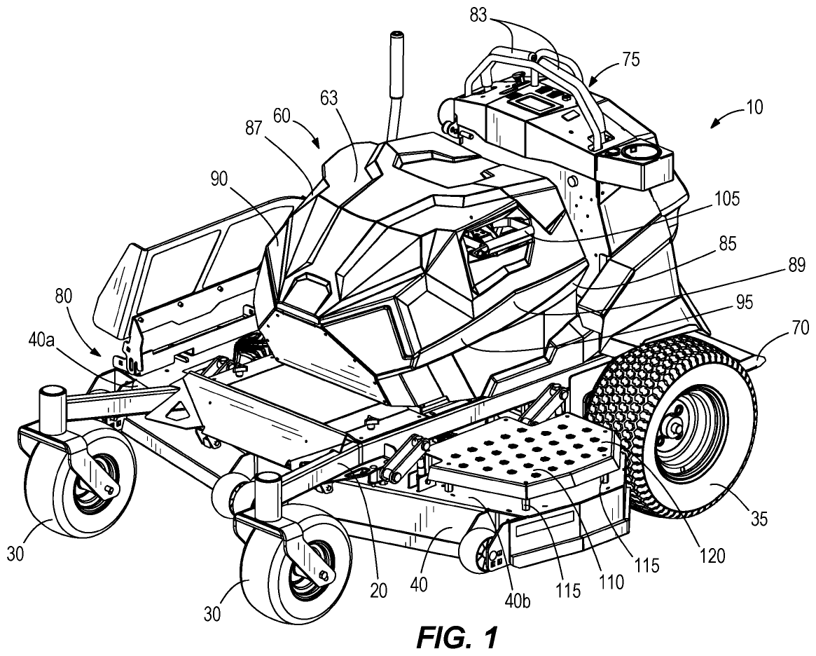

FIGS. 1-6 illustrate an outdoor power equipment (OPE) vehicle in the form of an electric battery powered stand-on lawn mower 10. In the following description of the drawings, directional terms such as left, right, front, rear, up, down, and the like are from the perspective of an operator in an ordinary operating position on the lawn mower during the ordinary operation of the lawn mower 10.

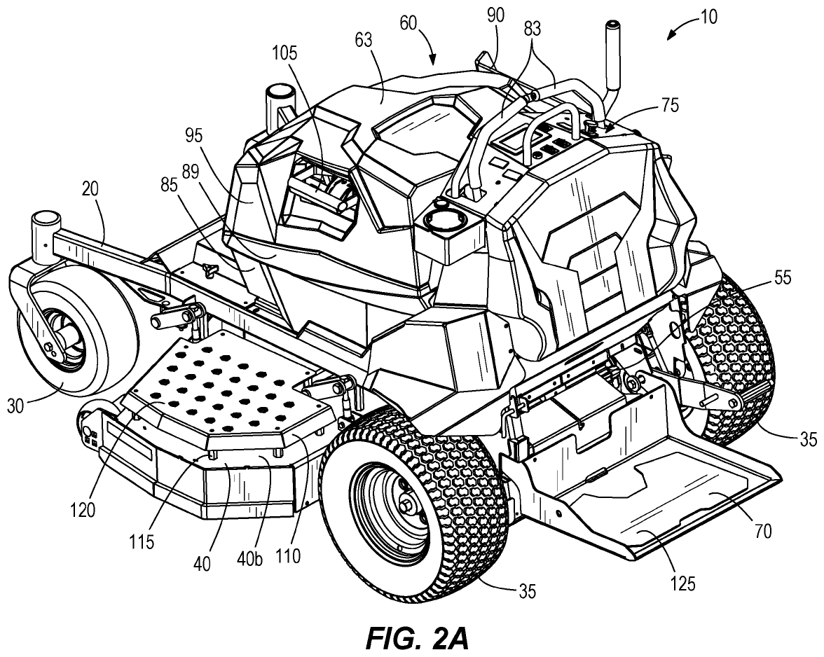

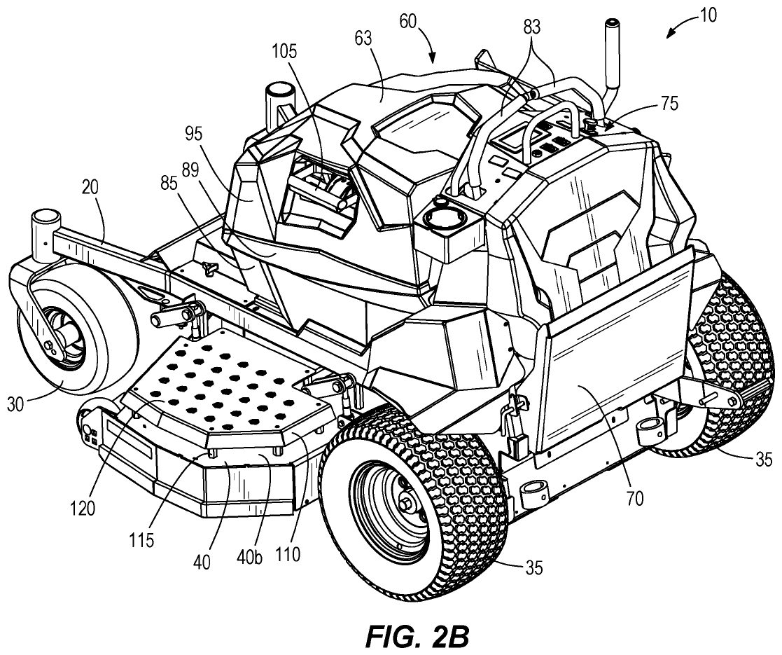

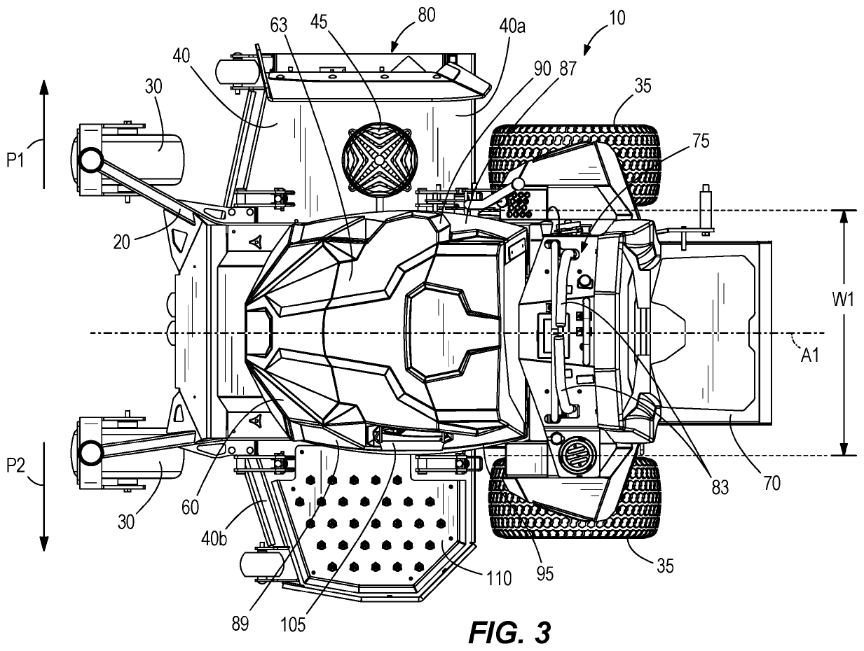

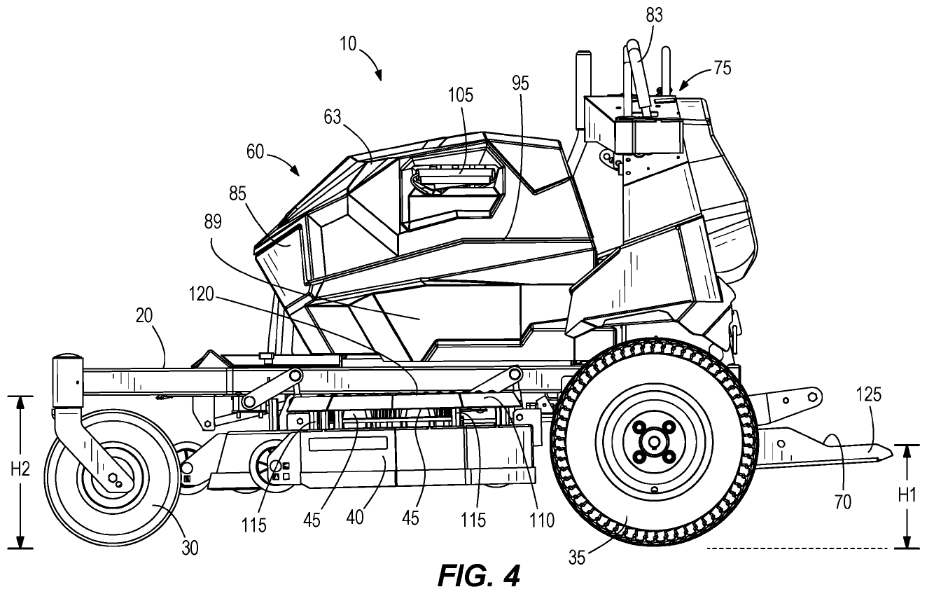

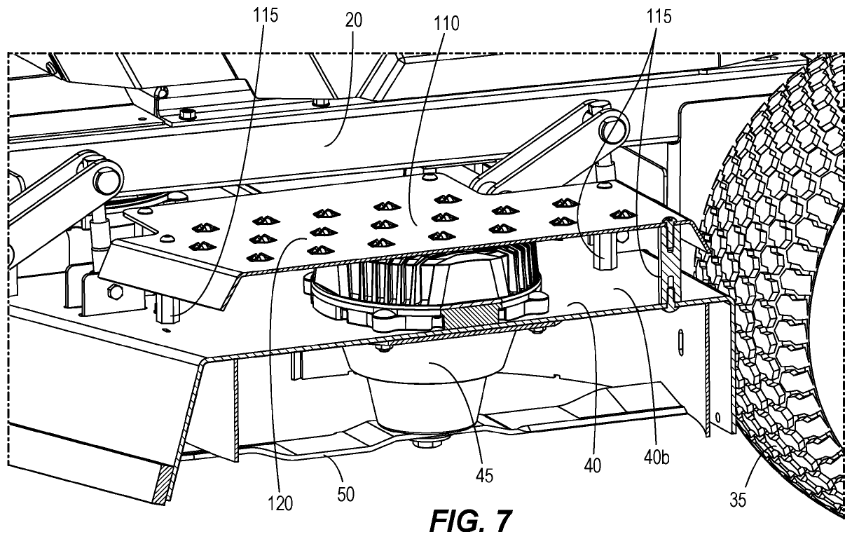

The lawn mower 10 includes a frame 20, front left and right caster wheels 30, rear left and right drive wheels 35, a cutting deck 40, deck motors 45 (FIGS. 3 and 4), cutting blades 50 (FIG. 7), drive motors 55 (FIG. 2A), a battery compartment 60 having a lid 63, a plurality of removable battery packs 65, an operator platform 70, and a user interface 75. The mower 10 further defines a front end, a rear end, a first side (e.g., a right side) extending between the front and rear ends, and a second side (e.g., a left side) extending between the front and rear ends.

As illustrated in FIGS. 1 and 2, the frame 20 defines the basic body structure or chassis of the lawn mower 10 and supports the other components of the lawn mower 10. The frame 20 additionally defines a longitudinal axis A1 (FIG. 3) that extends centrally through the mower 10 from a rear end to a front end of the mower 10. The frame 20 is supported by the front left and right caster wheels 30 and the rear left and right drive wheels 35. The caster wheels 30 rotate passively as the lawn mower 10 moves over the ground and swivel about a vertical axis. The drive wheels 35 are driven to cause the lawn mower 10 to move and steer over the ground, as will be described below. In other embodiments, the caster wheels 30 and/or the drive wheels 35 are replaced with other ground-engaging elements, such as tracks. In other embodiments, the caster wheels 30 and drive wheels 35 are all driven wheels that move and steer the OPE vehicle by skid steering.

The cutting deck 40 is movably suspended from the frame 20, under the frame 20, such that the cutting deck 40 can be raised or lowered with respect to the frame 20 to adjust the height of cut or put the cutting deck 40 in a relatively high position for transport. As seen in FIG. 7, the deck motors 45 are mounted to the cutting deck 40. Each deck motor 45 includes a vertical motor shaft and spindle under the cutting deck 40, to which a cutting blade 50 is mounted. The cutting blade 50 rotates under the influence of the associated deck motor 45 to cut grass and other vegetation under the cutting deck 40. Additionally, as illustrated in FIG. 3, the cutting deck 40 includes a first side portion 40a extending laterally outward from the battery compartment 60 in a first direction P1 and a second side portion 40b extending laterally outward from the battery compartment 60 in a second direction P2 opposite the first direction P1. The cutting deck 40 defines a discharge opening 80 therein. The discharge opening 80 is provided on the first side portion 40a of the cutting deck 40. That is, the discharge opening 80 is provided on the right side of the lawn mower 10 as viewed from an operator standing on the operator platform 70.

The discharge opening 80 provides an outlet from the cutting deck 40 for the grass and other vegetation cut by the cutting blade 50. In other embodiments, the cutting deck 40 may be a rear discharge cutting deck such that the discharge opening is positioned on a rear portion of the cutting deck between the drive wheels 35.

The drive wheels 35 are rotated by the drive motors 55 (FIG. 2A) at a selected speed and direction, as dictated by user controls in the user interface 75, to affect the movement and steering of the lawn mower 10 in the well-known manner of a zero turn radius lawn mower. In the illustrated embodiment, the lawn mower 10 is in the form of a stand-on mower, but in other embodiments, the lawn mower 10 is configured in the style of a zero-turn radius mower for a seated operator.

With reference to FIGS. 2A and 2B, the operator platform 70 is pivotably coupled to and supported by the frame 20 rearward of the user interface 75. The operator platform 70 is movable between a first position (FIG. 2A) and a second position (FIG. 2B). In the first position, the operator platform 70 extends rearward of the drive wheels 35 so that a standing operator can control the lawn mower 10. An operator zone is defined as the operator platform 70 and the hand and foot controls within the user interface 75 that can be reached by the user while standing on the operator platform 70. In other words, the operator platform 70 is configured to support a standing operator to enable the standing operator to manipulate the user interface 75 while standing on the platform 70. In the second position, the operator platform 70 is positioned in a stored position such that the operator can walk behind the mower 10 during operation. In other words, the mower 10 may be operated as a stand-on vehicle or a walk behind vehicle.

The user interface 75 includes maneuvering controls 83 operable to control the lawn mower 10, for example, by providing drive commands to the drive motors 55 (FIG. 2A) in response to user manipulation of the maneuvering controls 83. Specifically, the user interface 75 is operably connected to a power circuit for the mower 10 to control a direction and speed of rotation of the drive wheels 35 under the influence of the motor 55 (FIG. 2A). As such, the user interface 75 may additionally be referred to as a control. The user interface 75 includes other controls such as a mower deck height of cut setting and a parking brake. The user interface 75 also includes a user display for a vehicle control module. The user display displays a state of charge of the battery packs 65, faults occurring on the mower 10, and an operational state of the lawn mower 10.

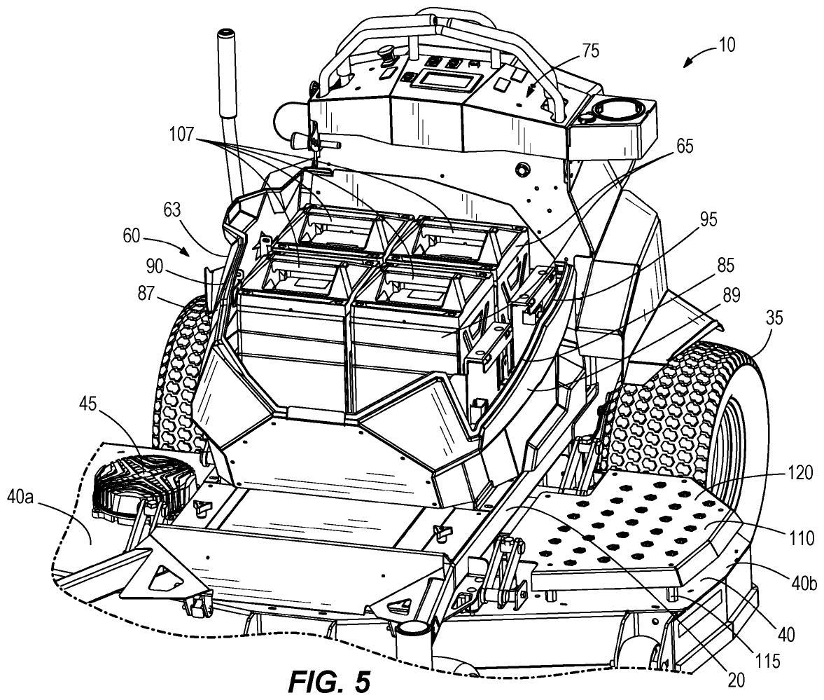

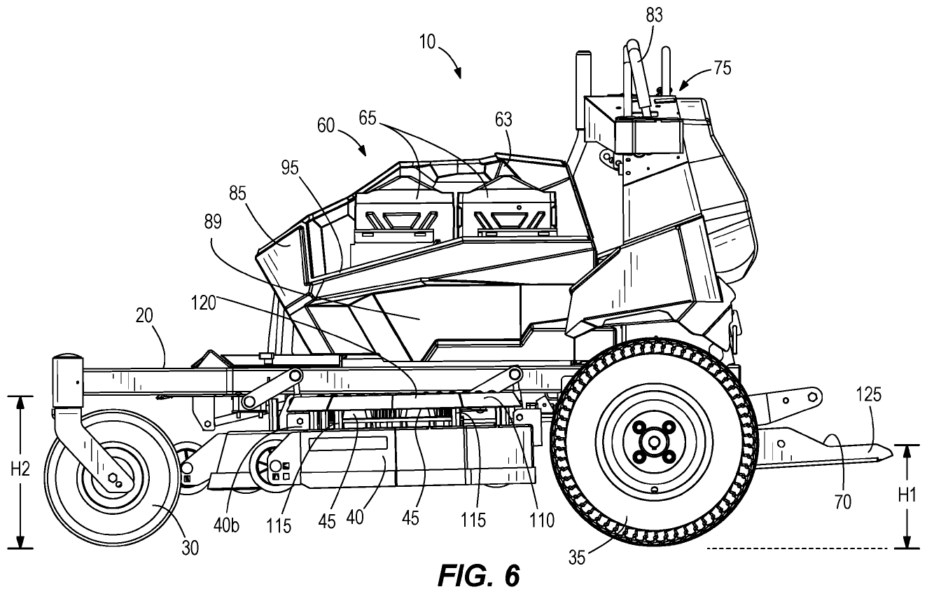

Turning now to FIGS. 5 and 6, the battery compartment 60 is supported by the frame 20 and is centrally located in the lawn mower 10, in front of the user interface 75. Stated another way, the battery compartment 60 is centered on the longitudinal axis Al (FIG. 3) of the frame 20. The battery compartment 60 has a width W1 (FIG. 3) that is measured on a plane transverse (e.g., perpendicular) to the longitudinal axis A1 (FIG. 3). The cutting deck 40 is wider than the width W1 (FIG. 3) of the battery compartment 60 such that the side portions 40a, 40b of the cutting deck 40 extends beyond the battery compartment 60 when viewed from above (FIG. 3). The user interface 75 is positioned between the operator platform 70 and the battery compartment 60. The battery compartment 60 includes an internal bus bar that provides an electrical connecting means to the power circuit for the lawn mower 10. The battery compartment 60 additionally includes a housing 85 that receives and contains the plurality of battery packs 65, which are electrically coupled to the drive motors 55 (FIG. 2A) and deck motors 45, through the bus bar, to provide sufficient power for their operation.

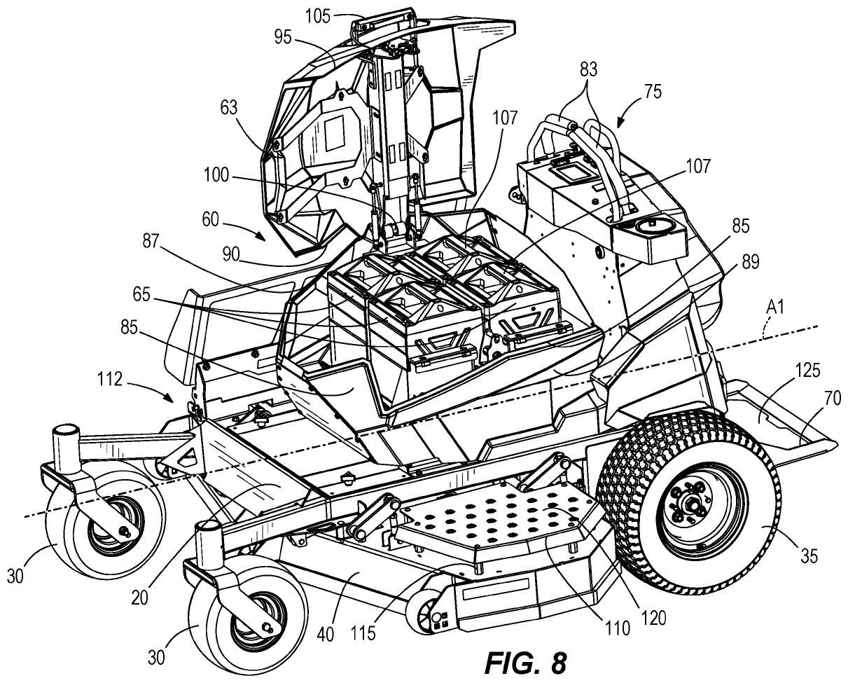

With continued reference to FIGS. 5 and 6, the housing 85 includes a first housing side 87 and a second housing side 89 opposite the first housing side 87. The first and second housing sides 87, 89 each extend partially between the front and rear ends of the mower 10 along the longitudinal axis A1 (FIGS. 3 and 8). The lid 63 includes a first lid side 90 and a second lid side 95 that is opposite the first lid side 90. In the illustrated embodiment, the first housing side 87 and the first lid side 90 are provided on the right side of the mower 10 as viewed from an operator standing on the operator platform 70, and the second housing side 89 and the second lid side 95 are provided on the left side of the mower 10 as viewed from an operator standing on the operator platform 70. Turning to FIG. 8, the lid 63 is pivotally coupled to the first housing side 87 of the battery compartment 60 at a pivot point 100 positioned proximate to the first lid side 90 (FIG. 5). As such, the pivot point 100 is offset from the longitudinal axis A1. The lid 63 is pivotable about the pivot point 100 between a closed position where the lid 63 covers the battery packs 65 within the battery compartment 60, as illustrated in FIG. 1, and an open position where the battery packs 65 positioned within the battery compartment 60 are accessible to the operator, as illustrated in FIG. 8. In other words, the battery compartment is accessible by the operator from the second side of the mower 10 (e.g., the left side of the mower). While the pivot point 100 is positioned on the right side of the mower 10 in the illustrated embodiment, it should be appreciated that the pivot point 100 may be positioned on the left side of the mower 10 so the battery compartment is accessible from the right side of the mower. The lid 63 includes a handle 105, (e.g. a first handle), that is coupled to the second lid side 95 (FIG. 5) of the lid 63 and is graspable by an operator to enable the operator to move the lid 63 between the closed position and the open position. The handle 105 extends parallel to the longitudinal axis Al.

The battery packs 65 are removably supported within the battery compartment 60. Each of the battery packs 65 includes a handle 107, a second handle, that is configured to be grasped by an operator to facilitate insertion and removal of the battery packs 65 with respect to the battery compartment 60. In the illustrated embodiment, the handle 107 is transverse to the longitudinal axis Al when the battery packs 65 are positioned within the battery compartment 60. More specifically, the handle 107 extends perpendicularly to the longitudinal axis A1. The battery packs 65 are covered by the lid 63 of the battery compartment during operation of the lawn mower 10. Each battery pack 65 can be manually lifted out of the battery compartment 60 or manually lowered into the battery compartment 60.

With reference to FIGS. 7 and 8, a step plate 110 is mounted to the frame 20 at a position proximate the battery compartment 60. More specifically, the step plate 110 is mounted to the cutting deck 40 over the left side deck motor 45 at the second portion 40b of the cutting deck 40 that is provided to the second lid side 95 (FIG. 5) of the lid 63 of the battery compartment 60. As such, the step plate 110 is positioned opposite the discharge opening 112 from the battery compartment 60. The step plate 110 is mounted between the caster wheel 30 and the drive wheel 35 on the left side of the mower 10 as viewed from an operator standing on the operator platform 70.

The step plate 110 is supported by multiple pillars 115 which are fastened with bolts at upper and lower ends to the step plate 110 and cutting deck 40. The step plate 110 is configured to support an operator to facilitate insertion and removal of the battery packs 65 with respect to the battery compartment 60. As such, an operator standing on the step plate 110 is given sufficient height, proximity, and leverage to insert (lower) and remove (lift) battery packs 65 with relative ease into and out of the battery compartment 60. Specifically, as illustrated in FIG. 6, a top surface 120 of the step plate 110 is provided above a top surface 125 of the operator platform 70. That is, a top surface 125 of the operator platform 70 is a first height H1 above the ground surface, a top surface 120 of the step plate 110 is a second height H2 above the ground surface, and the second height H2 is larger than the first height H1. The step plate 110 permits the battery compartment 60 to be stationary and fixed and obviates any need for pivoting or tipping the battery compartment 60 to facilitate the operator's insertion and removal of the battery packs 65. The positioning of the step plate 110 also permits the battery compartment 60 to be centered on the frame 20 to avoid imbalances. In addition, orienting the handles 107 transverse to the longitudinal axis allows for easier removal and insertion of the battery packs 65. In particular, the orientation of the handles 107 allows the operator to have more leverage as the operator removes the battery packs 65 from the side of the mower 10.

To remove the battery packs 65 from the battery compartment 60, an operator may first step onto the step plate 110. With the lid 63 in the closed position, the operator may grab the handle 105 of the lid 63 with one hand and rotate the lid 63 about the pivot point 100 to the open position. While still grasping onto the handle 105 of the lid 63 for support, the operator may then grab the handle 107 of one of the battery packs 65 with another hand. The operator is then enabled to lift the battery pack 65 from the battery compartment 60. The process for inserting the battery packs 65 into the battery compartment 60 is substantially similar to the process for removing the battery packs 65, except that the operator lowers one of the battery packs 65 into the battery compartment 60 instead of lifting one of the battery packs 65 out of the battery compartment 60. The battery packs 65 are placed in electrical contact with the power circuit of the mower 10 as a consequence of the battery packs 65 being inserted into the battery compartment 60. Furthermore, the battery packs 65 are removed from electrical contact with the power circuit of the mower 10 as a consequence of being removed from the battery compartment 60. Although a process for inserting and removing the battery packs 65 from the battery compartment 60 has been described herein, insertion and removal of the battery packs 65 from the battery compartment 60 is not limited to the description above.

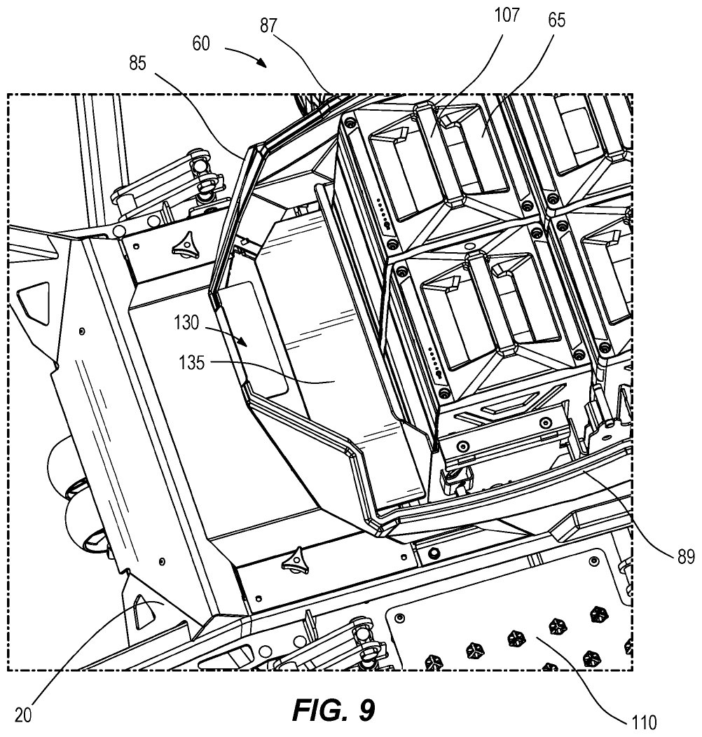

Now with reference to FIG. 9, the battery compartment 60 includes further includes a storage compartment 130 having a storage shelf 135. The storage compartment 130 is defined by the housing 85 and the storage shelf 135 at a position forward of the battery packs 65 (e.g., in a direction along the longitudinal axis A1). The storage compartment 130 may hold personal items of the operator (e.g., tools, clothing, or the like). The position of the storage compartment 130 allows the operator to access the storage compartment 130 when the operator is standing on the step plate 110. While the storage compartment 130 is positioned in front of the battery packs 65 in the illustrated embodiment, it should be appreciated that the storage compartment 130 may be alternatively positioned within the battery compartment 60 such that storage compartment is accessible from the side of the mower 10.

Various features and advantage of the invention are set forth in the following claims.

What is claimed is:

1. A utility vehicle having a front end, a rear end, a first side extending between the front and rear ends, and a second side extending between the front and rear ends opposite the first side, the utility vehicle comprising:
a frame defining a longitudinal axis that extends centrally through the vehicle from the rear end to the front end of the vehicle;
a battery compartment supported by the frame and having an internal bus bar, the battery compartment having a housing and a lid pivotally coupled to the housing at a pivot point positioned proximate the first side of the vehicle;
a battery pack removably supported within the battery compartment, the battery pack being placed in electrical contact with a power circuit as a consequence of being inserted into the battery compartment and removed from electrical contact with the power circuit as a consequence of being removed from the battery compartment;
a motor supported by the frame and in electrical communication with the power circuit to receive power from the battery pack;
a ground engaging element supporting the frame with respect to a ground surface and rotatable under the influence of the motor to move the utility vehicle over the ground surface; and
a control operably connected to the power circuit to control a direction and speed of rotation of the ground engaging element under the influence of the motor,
wherein the lid is configured to be movable between a closed position where the battery pack is covered within the battery compartment and an open position where the battery pack within the battery compartment is accessible by the operator from the second side of the vehicle.

2. The utility vehicle of claim 1, further comprising an operator platform coupled to the frame and configured to support a standing operator to enable the standing operator to manipulate the control while standing on the operator platform, and wherein the control is positioned between the battery compartment and the operator platform.

3. The utility vehicle of claim 1, wherein the battery compartment include a storage compartment configured to receive personal items of the operator.

4. The utility vehicle of claim 1, wherein
the battery pack includes a handle configured to be grasped by an operator to facilitate insertion and removal of the battery pack with respect to the battery compartment, and
the handle is transverse to the longitudinal axis when the battery pack is positioned within the battery compartment.

5. The utility vehicle of claim 1, further comprising a step plate coupled to the frame at a position proximate the battery compartment, the step plate configured to support the operator to facilitate insertion and removal of the battery pack with respect to the battery compartment.

6. The utility vehicle of claim 5, further comprising
a cutting deck coupled to the frame,
a cutting blade mounted below the cutting deck to cut vegetation under the cutting deck, and
wherein the step plate is mounted to the cutting deck.

7. The utility vehicle of claim 6, wherein a deck motor is coupled to the cutting deck and is configured to drive the cutting blade, and wherein the step plate is coupled to the cutting deck via pillars such that the step plate is spaced from the deck motor.

8. The utility vehicle of claim 5, further comprising an operator platform coupled to the frame and configured to support a standing operator to enable the standing operator to manipulate the control while standing on the operator platform, wherein a top surface of the operator platform is a first height above the ground surface, a top surface of the step plate is a second height above the ground surface, and the second height is larger than the first height.

9. The utility vehicle of claim 6, wherein:
the battery compartment is centered on the longitudinal axis of the frame and has a width measured on a plane transverse the longitudinal axis;
the cutting deck is wider than the battery compartment such that a side portion of the cutting deck is to a side of the battery compartment; and
the step plate is coupled to the side portion of the cutting deck.

10. A utility vehicle comprising:
a frame;
a battery compartment coupled to the frame and having an internal busbar;
a battery pack removably supported within the battery compartment, the battery pack being placed in electrical contact with a power circuit as a consequence of being inserted into the battery compartment and removed from electrical contact with the power circuit as consequence of being removed from the battery compartment;
a motor supported by the frame and in electrical communication with the power circuit to receive power from the battery pack;
a ground engaging element supporting the frame with respect to a ground surface and rotatable under the influence of the motor to move the utility vehicle over the ground surface;
a control operably connected to the power circuit to control a direction and speed of rotation of the ground engaging element under the influence of the motor;
an operator platform coupled to the frame and configured to support a standing operator to enable the standing operator to manipulate the control while standing on the operator platform; and
a step plate coupled to the frame at a position proximate the battery compartment, the step plate configured to support the operator to facilitate insertion and removal of the battery pack with respect to the battery compartment.

11. The utility vehicle of claim 10, wherein the battery compartment includes
a housing for receiving the battery pack,
a lid having a first lid side and a second lid side opposite the first lid side, the lid pivotally coupled to the housing at a pivot point positioned proximate the first side of the vehicle, the lid configured to be movable between a closed position where the battery pack is covered within the battery compartment and an open position where the battery pack within the battery compartment is accessible by the operator from the second side of the vehicle, and
a first handle coupled to the second side of the lid.

12. The utility vehicle of claim 11, wherein the step plate is coupled to the frame at a position proximate the second side of the lid so the first handle is graspable by the operator when the operator is positioned on the step plate, wherein the battery pack includes a second handle, and wherein the first handle is graspable with one hand of the operator and the second handle is graspable by a second hand of the operator to remove the battery pack from the battery compartment when the lid is in the open position.

13. The utility vehicle of claim 11, wherein a longitudinal axis extends centrally through the utility vehicle between a front end and a rear end of the utility vehicle, and wherein the pivot point is parallel to and offset from the longitudinal axis.

14. The utility vehicle of claim 10, further comprising
a cutting deck coupled to the frame,
a cutting blade mounted below the cutting deck to cut vegetation under the cutting deck, and
wherein the step plate is mounted to the cutting deck.

15. The utility vehicle of claim 14, wherein a deck motor is coupled to the cutting deck and is configured to drive the cutting blade, and wherein the step plate is coupled to the cutting deck via pillars such that the step plate is spaced from the deck motor.

16. A utility vehicle comprising:
a frame;
a battery compartment supported by the frame and configured to support a battery pack, the battery pack placed in electrical contact with a power circuit;
a motor supported by the frame and in electrical communication with the power circuit to receive power from the battery pack;
a cutting deck coupled to the frame;
a cutting blade mounted below the cutting deck to cut vegetation under the cutting deck;
a ground engaging element supporting the frame with respect to a ground surface and being rotatable under the influence of the motor to move the utility vehicle over the ground surface;
a control operably connected to the power circuit to control a direction and speed of rotation of the ground engaging element under the influence of the motor; and
a step plate coupled to the cutting deck at a position proximate the battery compartment, the step plate configured to support the operator to facilitate insertion and removal of the battery pack with respect to the battery compartment.

17. The utility vehicle of claim 16, wherein the cutting deck defines a discharge opening therein, and wherein the step plate is coupled to the cutting deck at a position opposite the discharge opening.

18. The utility vehicle of claim 17, wherein the ground engaging element is one of a plurality of ground engaging elements such that the utility vehicle further comprises a front ground engaging element and a rear ground engaging element, and wherein each of the discharge opening and the step plate is positioned between the front ground engaging element and the rear ground engaging element.

19. The utility vehicle of claim 16, wherein
the utility vehicle has a front end, a rear end, a first side extending between front and rear ends, and a second side extending between the front and rear ends opposite the first side,
a longitudinal axis extends from the rear end to the front end of the utility vehicle,
the battery pack includes a handle configured to be grasped by an operator to facilitate insertion and removal of the battery pack with respect to the battery compartment from the first or second side of the vehicle, and
the handle is transverse to the longitudinal axis when the battery pack are positioned within the battery compartment.

20. The utility vehicle of claim 16, further comprising an operator platform coupled to the frame and configured to support a standing operator to enable the standing operator to manipulate the control while standing on the operator platform, and wherein the control is positioned between the battery compartment and the operator platform.
